(19) United States
(12) Patent Application Publication
(10) Pub. No.: US 2016/0082438 A1
(43) Pub. Date: Mar. 24, 2016

(54) PRESSURE BASED DISPENSING

(71) Applicant: GenCell Biosystems Ltd., Raheen (IE)

(72) Inventors: David McGuire, Enniscorthy (IE); Maria O'Connor, Croom (IE); Mark Dalton, Limerick (IE); Kevin Daulnay, Dublin (IE); David Merrigan, Shannon (IE)

(21) Appl. No.: 14/861,172

(22) Filed: Sep. 22, 2015

Related U.S. Application Data
(60) Provisional application No. 62/053,938, filed on Sep. 23, 2014.

(51) Int. Cl. B01L 3/00; B01J 19/00; G01N 1/28

(52) U.S. Cl. CPC B01L 3/52; G01N 1/28; B01J 19/0046; B01J 2219/00585; B01J 2219/00418; B01L 2200/0605; B01L 2400/0403

(57) ABSTRACT

Aspects of the present disclosure provide a composite liquid cell handling system, composite liquid cell processing methods, and dispensing heads for use in the systems and methods.

### CROSS-REFERENCE TO RELATED APPLICATIONS

Pursuant to 35 U.S.C. §119 (e), this application claims the benefit of priority to U.S. Provisional Patent Application Ser. No. 62/053,938, filed Sep. 23, 2014, the disclosure of which application is hereby incorporated by reference herein in its entirety.

### BACKGROUND

Processing of biological samples can be advantageously done within a fluid handling system configured for manipulating multiple liquids, e.g., samples and reagents, in a defined manner. Certain fluid handling systems generate and/or otherwise employ composite liquid cells (CLCs) for the processing of biological samples. Typically, CLCs are centered around an aqueous phase which contains a biological sample or other reagent(s). The aqueous phase floats on top of a carrier fluid immiscible with and denser than water. Above the aqueous phase is an encapsulating fluid that is immiscible with both water and the carrier fluid, and is less dense than both water and the carrier fluid. In this way a CLC is “triphasic”, that is, it includes three mutually immiscible phases: carrier, sample and encapsulant. CLCs can be easily manipulated, moved from one location to another, added to, merged, split, etc. Encapsulation leaves CLCs essentially free of contamination. CLCs can also be formed down to very small sizes, and the small volumes involved allow for highly efficient use of potentially expensive reagents. CLCs are described in more detail in U.S. Pat. No. 8,465,707, which is hereby incorporated herein by reference in its entirety.

All these factors mean that CLCs are excellent venues for biological sample processing, for example, in performing polymerase chain reactions (PCR), digital PCR (dPCR), quantative PCR (qPCR), transcription-mediated amplification (TMA), branched-DNA assays (bDNA), ligase chain reacation assays (LCR), and nucleic acid library preparation.

An important aspect of the creation and handling of CLCs is the accurate, reliable, and efficient dispensing of each of several liquids, e.g., carrier, sample, and encapsulating liquids. Such liquid handling is important in any system for processing biological samples, but especially where the metered amounts of liquid are small, and several different types of liquids must be handled in a single system, as in CLC-based systems.

### SUMMARY

Devices, systems and methods for aspirating and/or dispensing liquids are disclosed.

Aspects of the present disclosure provide a composite liquid cell handling system, composite liquid cell processing methods, and dispensing heads for use in the systems and methods.

In certain embodiments, a composite liquid cell handling system can include a dispensing head, a pressure source, and controller. The dispensing head can have two opposing faces, a dispensing face and a rear face, and the head can include a liquid conduit (e.g., at least one liquid conduit, or a plurality of liquid conduits). Each liquid conduit can provide a pathway for fluid communication between the faces. The pressure source can be operably attached to the dispensing head and capable of applying either positive or negative pressure to the rear face and thereby to the liquid conduit (or to the plurality of liquid conduits collectively). That is, the pressure source can apply pressure, either negative or positive, to the conduits in parallel by applying a pressure to the entire rear face of the head. The controller can be operably attached to the pressure source and capable of causing the pressure source to apply either positive or negative pressure to the rear face, the controller including an input device.

The controller can be programmable to control the pressure source in a wide variety of ways. For example, the controller may be configured to receive at its input signals representative of (i) a predetermined dispensing quantity of liquid, (ii) a predetermined viscosity, and (iii) a predetermined volume of each liquid conduit. Based on those three parameters and the known geometry of the liquid conduits, the controller may be configured to determine a paired pressure and time interval such that, if the determined pressure were applied to the rear face for a time equal to the determined time interval, and each of the conduits was charged with at least the predetermined volume of a liquid having the predetermined viscosity, the predetermined quantity of the liquid would be dispensed from each conduit at the dispensing face. The controller may be configured to be programmed to also cause the pressure source to apply the determined pressure to the rear face for a time equal to the determined time interval. The liquid may be, for example, water, an aqueous solution, a fluorocarbon oil, or a silicone oil, all of which may have different viscosities. The controller may configured to be able to variably determine times and pressures for a variety of different tasks, including aspiration and dispensing of various different amounts of various different liquids.

Applying a positive pressure to the rear face result in some instances in dispensing of liquid already in the conduits. Applying a negative pressure to the rear face results in some instances in aspiration of liquid in contact with the dispensing face of the liquid conduits. A single head may be used both for aspiration of liquid into the liquid conduits through the dispensing face and for dispensing of liquid from the liquid conduit(s) out of the dispensing face.

Regardless of what the controller is programmed to do, it may be advantageous to make at least a portion of an internal wall that defines each liquid conduit both hydrophobic and oleophobic. In particular, the portion of the internal wall adjacent to the dispensing face can be both hydrophobic and oleophobic.

In some embodiments, a portion of the liquid conduit adjacent to the dispensing face, can define a capillary section sized and shaped such that a predetermined liquid disposed within the capillary section would experience a capillary surface tension force that is greater than a predetermined pressure force across the opening of the liquid conduit in the dispensing face, thereby substantially retaining the liquid in the liquid conduit. Such a capillary section can be designed to prevent drips of one or more types of liquid to be retained in the liquid conduit despite the presence of a positive pressure across the rear face of the conduit.

In some embodiments, a system can also include a transport capable of translating the dispensing head to any of a plurality of locations. In such a system, a liquid can be both aspirated into and dispensed from a single dispensing head by: (1) with the transport, translating the dispensing head to a location where the dispensing face is in contact with a liquid; (2) with the controller, causing the pressure source to apply a negative pressure to the rear face of the dispensing head, thereby aspirating the liquid through the dispensing face into the liquid conduit(s); (3) with the transport, translating the dispensing head to a dispensing location; and (4) with the controller, causing the pressure source to apply a positive pressure to the rear face of the dispensing head, thereby dispensing at least a portion of the aspirated liquid through the dispensing face from the liquid conduit(s).

In some embodiments, a system can include a plurality of dispensing heads, and a transport capable of (a) operably attaching to the pressure source any one of the plurality dispensing heads, and (b) removing from operable attachment to the pressure source a dispensing head operably attached to the pressure source. Such a system can be used to handle liquids such that each of the dispensing heads is used in sequence, having a limited duty cycle. For example, the system could: (1) with the transport, operably attach to the pressure source a first of the plurality of dispensing heads; (2) with the controller, cause the pressure source to apply a positive pressure to the rear face of the attached first dispensing head, thereby dispensing a liquid from the liquid conduit(s) of the attached first dispensing head; (3) with the transport, remove from operable attachment to the pressure source the first dispensing head; (4) with the transport, operably attach to the pressure source a second of the plurality of dispensing heads different from the first dispensing head; (5) with the controller, cause the pressure source to apply a positive pressure to the rear face of the attached second dispensing head, thereby dispensing a liquid from the liquid conduit(s) of the attached second dispensing head; (6) with the transport, remove from operable attachment to the pressure source the second dispensing head; and (7) repeat steps (1)-(6).

### BRIEF DESCRIPTION OF THE DRAWINGS

Aspects of the disclosure may be best understood from the following detailed description when read in conjunction with the accompanying drawings.

Included in the drawings are the following figures:

FIG. 1A-1C provide schematic illustrations of three examples of dispensing heads for use in a liquid handling system according to aspects of the present disclosure. FIG. 1A shows a dispensing head having a 3×8 array of conduits (24 total conduits); FIG. 1B shows a dispensing head having 6 in-line conduits; FIG. 1C shows a dispensing head having a 2×3 array of conduits (6 total conduits).

FIG. 2 is a schematic illustration showing details of the dispensing head shown in FIG. 1A (reproduced at the top left of the figure).

FIG. 3 is a schematic showing a detailed cross-sectional view of conduits of the dispensing head shown in FIG. 1A and FIG. 2.

FIG. 4 is a schematic illustration showing details of the dispensing head shown in FIG. 1B (reproduced at the top of the figure).

FIG. 5 is a schematic illustration showing details of the dispensing head shown in FIG. 1C (reproduced at the top of the figure).

### DETAILED DESCRIPTION

Aspects of the present disclosure provide a composite liquid cell handling system, composite liquid cell processing methods, and dispensing heads for use in the systems and methods.

Before the present invention is described in greater detail, it is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Composite Liquid Cell Handling Systems and Methods of Use

Aspects of the present disclosure include a composite liquid cell handling system that includes a dispensing head having a liquid conduit (or a plurality of liquid conduits) and a pressure source that can be operably attached to the dispensing head and configured to modulate the pressure in the liquid conduit (or the plurality of liquid conduits collectively). The composite liquid cell handling systems described herein can further include a controller operably attached to the pressure source and, in some embodiments, operably attached to a transporter. The controller can be configured to receive one or more signals (e.g., from an input device) that control the movement of the dispensing head to a plurality of locations in the system and to modulate the pressure applied to the liquid conduit(s) in the dispensing head. While some embodiments of the dispensing heads described herein are described as having “a liquid conduit” rather than “a plurality of liquid conduits” (or vice versa), it is intended that both of these embodiments are intended unless clearly excluded by the context of the embodiment.

Composite Liquid Cells (CLCS)

The dispensing heads, composite liquid cell handling systems, and other components described herein are designed to be used in Composite Liquid Cell-based (CLC-based) sample manipulation. By CLC is meant a triphasic fluid arrangement that is a combination of at least three substantially mutually immiscible fluids having three different densities. The first fluid is a carrier fluid which is the densest of the three substantially mutually immiscible fluids; the second fluid is an encapsulating fluid which is the least dense of the substantially mutually immiscible fluids; and the third fluid is a target fluid (sometimes referred to as a “sample”) which has a density that is less than the first fluid and greater than the second fluid. A CLC may take a variety of different forms, where in some embodiments the target fluid is encased in the encapsulating fluid and where the resulting roughly spherical structure is present on the surface of the carrier fluid. In this form, the carrier fluid is not fully covered by the encapsulating fluid. In other embodiments, the target fluid is encased (or encapsulated) between the carrier fluid and the encapsulating fluid. For example, if the CLC is present in a self-contained well, the entire surface of the carrier fluid in the well can be covered by the encapsulating fluid with the sample encapsulated therebetween.

In certain embodiments, the target fluid is an aqueous fluid, where in some embodiments the aqueous fluid contains a biological sample, reagent, buffer, or other prescribed element of a genetic assay. Examples of components that can be present in the aqueous fluid include, but are not limited to: cells, nucleic acids, proteins, enzymes, biological sample (e.g., blood, saliva, etc.), buffers, salts, organic material, and any combination thereof.

In certain embodiments, the density of the carrier fluid is from 1,300 to 2,000 kg/m³, the density of the target fluid is from 900 to 1,200 kg/m³, and the density of the encapsulating fluid is from 700 to 990 kg/m³. The difference in density between the carrier fluid and the target fluid or between the target fluid and the encapsulating fluid is from 50 to 2000 kg/m³. In general, the difference in density between the three substantially mutually immiscible fluids should be sufficient to prevent substantial intermixing between any two of them under the conditions in which they are to be stored and/or used in any downstream process or analytical assay. Additional details regarding carrier, encapsulating and target fluids may be found in U.S. Pat. Nos. 8,465,707 and 9,080,208; as well as United States Patent Application Publication No. 20140371107; and Published PCT Application Nos: WO2014/083435; WO2014/188281; WO2014/207577; WO2015/075563; WO2015/075560; the disclosures of which applications are herein incorporated by reference.

In certain embodiments, the carrier fluid and/or the encapsulating fluid is an oil. For example, in certain embodiments, the carrier and/or the encapsulating fluid can be a silicone oil, a perfluorocarbon oil, or a perfluoroporyether oil. Thus, in certain embodiments, the carrier fluid is selected from fluorocarbonated oils. In certain embodiments, the encapsulating fluid is selected from silicone oils.

In embodiments in which the target fluid is an aqueous fluid, for example, a biological sample or an aqueous reagent, an example of a CLC includes one in which the carrier (first) fluid is Fluorinert FC-40 (fluorocarbonated oil) having a density of approximately 1,900 kg/m³, the second fluid is a phenylmethylpolvsiloxane (silicone oil) having a density of approximately 920 kg/m³, and the target fluid (sample) is an aqueous-based solution of biological components with a density of approximately 1000 kg/m³.

In certain embodiments, the volume of the target fluid (sample) in the CLC is from about 10 nanoliters (nL) to about 20 microliters (μL). As such, in certain embodiments, the volume of the sample is about 10 nL, about 20 nL, about 30 nL, about 40 nL, about 50 nL, about 60 nL, about 70 nL, about 80 nL, about 90 nL, about 100 nL, about 200 nL, about 300 nL, about 400 nL, about 500 nL, about 600 nL, about 700 nL, about 800 nL, about 900 nL, 1 μL, about 2 μL, about 3 μL, about 4 μL, about 5 μL, about 6 mL, about 7 μL, about 8 μL, about 9 μL, about 10 μL, about 11 μL, about 12 μL, about 13 μL, about 14 mL, about 15 μL, about 16 μL, about 17 μL, about 18 μL, about 19 μL, or about 20 μL.

The volume of the carrier and encapsulating fluid in a CLC should be sufficient to generate a composition in which the target fluid can be fully encapsulated within the encapsulating fluid or between the carrier and encapsulating fluids when present in a desired location, e.g., a well or a node, e.g., a self-contained well or a well have a common carrier fluid with other wells. By fully encapsulated is meant that the target fluid is in direct contact with only the encapsulating fluid and/or the carrier fluid. Thus, the target fluid is not in contact with either the bottom of the CLC reaction well (generally below the carrier fluid) or to the ambient environment (generally above the encapsulating fluid). The amount of fluid is thus dependent not only on the volume of the target fluid, but also on the interior dimensions of the CLC reaction well. While the volume of carrier and encapsulating fluid can vary greatly, in certain embodiments, the volume of the carrier fluid or the encapsulating fluid in the CLC is from about 1 μL to about 100 μL. As such, in certain embodiments, the volume of the carrier fluid or the encapsulating is about 1 μL, about 2 μL, about 3 μL, about 4 μL, about 5 μL, about 6 μL, about 7 μL, about 8 μL, about 9 μL, about 10 μL, about 11 μL, about 12 μL, about 13 μL, about 14 μL, about 15 μL, about 16 μL, about 17 μL, about 18 μL, about 19 μL, about 20 μL, about 25 μL, about 30 μL, about 35 μL, about 40 μL, about 45 μL, about 50 μL, about 55 μL, about 60 μL, about 65 μL, about 70 μL, about 75 μL, about 80 μL, about 85 μL, about 90 μL, about 95 μL, or about 100 μL.

Dispensing Head

Aspects of the present disclosure provide dispensing heads configured to access and transfer liquids, e.g., from a first location to a second location in a composite liquid cell handling system as described herein.

In certain embodiments, a dispensing head includes a rear face, a dispensing face disposed on the dispensing head opposite the rear face, and a liquid conduit providing a pathway for fluid communication between the rear face and the dispensing face. The rear face of the dispensing head is configured to operably attach (or engage) a pressure source that can apply a desired pressure to the rear face such that the pressure is applied to the liquid conduit. In certain embodiments, the dispensing head comprises a plurality of liquid conduits. In such embodiments, each of the plurality of liquid conduits opens at the rear face into a common pressure regulation region. This region can be spatially defined by the rear face of the dispensing head itself or by a region that is created at the interface between the rear face of the dispensing head and the portion of the pressure source that is configured to operably attach to the rear face.

As described in further detail herein, the pressure source can be controlled to apply a positive, negative, or neural pressure to the rear face (to the common pressure regulation region), and thus to the liquid conduit (or collectively to the plurality of liquid conduits), for a specific duration to effect a specific liquid handling action in the liquid conduit. Liquid handling actions include aspirating a liquid into the liquid conduit(s), dispensing a liquid from the liquid conduit(s), and retaining a liquid in the liquid conduit(s).

The liquid conduits in a dispensing head can have any of a variety of different forms or configurations and thus no specific limitation in this regard is intended. In certain embodiments, each of the plurality of liquid conduits in a dispensing head has the same (or similar) configuration such that when handling a specific liquid they each perform in a substantially uniform manner. For example, when handling a carrier liquid, each of the similarly-configured liquid conduits of a dispensing head will aspirate (or dispense) the same volume of the carrier fluid when a desired pressure is applied to the rear face for a desired duration. In other embodiments, one or more of the plurality of liquid conduits of a dispensing head can have a different configuration from one or more other of the plurality of liquid conduits. This difference in configuration may result in a liquid conduit performing differently from other liquid conduits in the same dispensing head such that when handling a specific liquid the different liquid conduits perform in a substantially non-uniform manner. For example, when handling a carrier liquid, each of the differently-configured liquid conduits of a dispensing head will aspirate (or dispense) a different volume of the carrier fluid when a desired pressure is applied to the rear face for a desired duration. It is noted that not all differences in the configuration of a liquid conduit, as compared to the other liquid conduits on the dispensing head, will translate into the liquid conduit performing in a non-uniform manner under all use conditions.

In general, a liquid conduit in the dispensing head includes a path through the main body of the dispensing head that allows a liquid to travel therethrough, e.g., under pressure applied at the rear face. In certain embodiments, in addition to the region through the main body of the dispensing head, a liquid conduit can have one or more additional structural regions that extend from the dispensing face (sometimes referred to as adjacent to the dispensing face). These structural regions can be in a variety of forms, including individual protrusions/extensions for each conduit (e.g., tubes, tips, nozzles, etc.) or a single protrusion/extension that defines regions of multiple conduits. These regions of each of the plurality of liquid conduits of the dispensing head can extend from about 1.0 to about 20.0 mm from the base of the dispensing face (i.e., the dispensing face side of the main body of the dispensing head), or any range therebetween, e.g., from about 3.0 mm to about 15.0 mm, including about 2.0 mm, about 3.0 mm, about 4.0 mm, about 5.0 mm, about 6.0 mm, about 7.0 mm, about 8.0 mm, about 9.0 mm, about 10.0 mm, about 11.0 mm, about 12.0 mm, about 13.0 mm, about 14.0 mm, about 15.0 mm, about 16.0 mm, about 17.0 mm, about 18.0 mm, about 19.0 mm, about 20.0 mm, etc. In certain embodiments, the diameter of the protrusion/extension region on the dispensing face of each of the plurality of liquid conduits is from about 0.5 mm to about 10 mm, or any range therebetween, e.g., from about 2 mm to about 5 mm, including about 0.6 mm, about 0.8 mm, about 1.0 mm, about 1.2 mm, about 1.4 mm, about 1.6 mm, about 1.8 mm, about 2.0 mm, about 2.2 mm, about 2.4 mm, about 2.6 mm, about 2.8 mm, about 3.0 mm, about 3.2 mm, about 3.4 mm, about 3.6 mm, about 3.8 mm, about 4.0 mm, about 4.2 mm, about 4.4 mm, about 4.6 mm, about 4.8 mm, about 5.0 mm, about 5.4 mm, about 5.8 mm, about 6.0 mm, about 7.0 mm, about 8.0 mm, about 9.0 mm, about 10.0 mm, etc.

The entirety of the path of a liquid conduit, i.e., from the opening at, or adjacent to, the rear face to the opening at, or adjacent to, the dispensing face, can have a variety of shapes and is defined by an internal wall. For example, the internal wall of a liquid conduit can define regions of that are substantially cylindrical, conical, frustoconical, or any other desired shape or combination of shapes. For example, a conduit can have a cylindrical region adjacent to the rear face that leads into a frustoconical region adjacent to the dispensing face. The internal wall can define different regions within a single liquid conduit, e.g., reservoir region that holds sufficient liquid for multiple dispensing actions, a dispensing region that holds liquid to be dispensed, a dispensing orifice (or opening) that exits the conduit on the dispensing face side, etc. In certain embodiments, the conduit defines a capillary section that leads directly to the opening of the conduit on the dispensing face side of the dispensing head (adjacent to the dispensing face). In certain embodiments, the capillary section is sized and shaped such that a predetermined liquid disposed within the capillary section would experience a capillary surface tension force that is greater than a predetermined pressure force across the opening of the liquid conduit in the dispensing face, thereby substantially retaining the liquid in the liquid conduit. In certain embodiments, the internal diameter of the capillary section of each of the plurality of liquid conduits and/or the opening of the conduits adjacent to the dispensing face is from about 10 microns (μm) (0.01 mm) to about 800 μm (or 0.80 mm), including from 10 μm to about 300 μm, e.g., about 20 μm, about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, etc.

In certain embodiments, the internal walls of a liquid conduit, or portions thereof, are configured to have a desired physical property, including hydrophobicity, hydrophilicity, oleophobicity, oleophilicity, combinations thereof, etc. For example, the internal wall, or a portion thereof, of a liquid conduit adjacent to the dispensing face can be both hydrophobic and oleophobic. Achieving a desired physical property of an internal wall of a conduit can be achieved in any convenient manner, for example by selecting a substrate or material for manufacturing the dispensing head that has a desired physical property and/or coating the internal wall of the conduits (or otherwise treating them) to impart the desired physical property.

When a plurality of liquid conduits are present on a dispensing head, they can be positioned in any manner that is desired by a user. For example, the plurality of liquid conduits can be arranged linearly or in a two-dimensional array on the dispensing head. The plurality of liquid conduits can be evenly spaced, i.e., such that each of the conduits is substantially the same distance from the next nearest conduit, or can be irregularly spaced. No limitation in the pattern of conduits is intended. The number of liquid conduits in a dispensing head may vary, where in some instances the number ranges from 5 to 1000, e.g., from 5 to 500, including from 12 to 768, such as 24 to 384, e.g., 24 to 96, including 24 to 48. In certain embodiments, the liquid conduits may be arranged in the dispensing head to readily align with wells of desired multi-well receptacle, e.g., a laboratory plate having multiple wells (e.g., a 24 well plate, a 96 well plate, etc.). For example, the liquid conduits can be in a 4×32 arrangement that aligns with wells as spaced in a standard 384 well plate, a 2×12 arrangement that aligns with wells as spaced in a 96 well plate, or other convenient arrangement. While in certain embodiments, the plurality of liquid conduits are arranged to align with a linear or two-dimensional array or adjacent wells in a multi-well receptacle, in other embodiments, the plurality of liquid conduits are aligned such that at least one of the liquid conduits is aligned with a non-adjacent well in the multi-well receptacle. In other words, it is not necessary for the plurality of liquid conduits to be arranged such that they are spaced to align only with adjacent wells in a multi-well receptacle. In some configurations, the plurality of liquid conduits are arranged to align with both adjacent wells and non-adjacent wells. For example, the liquid conduits can be spaced to align with adjacent wells in the columns and every other well (or every third well, every fourth well, every fifth well, etc.) in the rows of a multi-well receptacle having a two-dimensional array of wells (e.g., a 96 well plate). In addition, a two-dimensional array of conduits can have off-set rows or columns, e.g., in a “checkerboard” pattern where conduits in odd numbered rows of the two-dimensional array align with odd numbered wells in the receptacle and conduits in even numbered rows of the two-dimensional array align with even numbered wells in the receptacle. The plurality of liquid conduits on a dispensing head can be spaced from each other as necessary to perform as desired by a user. In certain embodiments, the distance between the center of a first liquid conduit to the center of the next nearest second liquid conduit is from about 4.00 mm to about 20.00 mm, including from about 4.50 mm to about 10.00 mm, about 5.00 mm to about 7.00 mm, about 5.50 mm to about 6.5 mm, etc. In embodiments in which the plurality of liquid conduits are regularly-spaced in at least a first linear dimension, the distance between the centers of adjacent liquid conduits in that dimension can be 4.00 mm, 4.10 mm, 4.20 mm, 4.30 mm, 4.40 mm, 4.50 mm, 4.60 mm, 4.70 mm, 4.80 mm, 4.90 mm, 5.00 mm, 5.10 mm, 5.20 mm, 5.30 mm, 5.40 mm, 5.50 mm, 5.60 mm, 5.70 mm, 5.80 mm, 5.90 mm, 6.00 mm, 6.10 mm, 6.20 mm, 6.30 mm, 6.40 mm, 6.50 mm, 6.60 mm, 6.70 mm, 6.80 mm, 6.90 mm, 7.00 mm, 7.10 mm, 7.20 mm, 7.30 mm, 7.40 mm, 7.50 mm, 7.60 mm, 7.70 mm, 7.80 mm, 7.90 mm, 8.00 mm, 8.10 mm, 8.20 mm, 8.30 mm, 8.40 mm, 8.50 mm, 8.60 mm, 8.70 mm, 8.80 mm, 8.90 mm, 9.00 mm, 9.50 mm, 10.00 mm, 10.50 mm, 11.00 mm, 11.50 mm, 12.00 mm, 12.5 mm, 13.00 mm, 13.5 mm, 14.0 mm, 14.5 mm, 15.00 mm, 15.50 mm, 16.00 mm, 17.00 mm, 18.00 mm, 19.00 mm, 20.00 mm, and anywhere in between. In general, the desired end-use of the dispensing head will be taken into consideration when determining/selecting the liquid conduit pattern.

As noted above, the rear face of the dispensing head is configured to be operably attached to a pressure source configured to modulate the pressure at the rear face and thereby in the liquid conduit/plurality of liquid conduits collectively (where by “collectively” is meant that the pressure is not modulated individually in each liquid conduit of the plurality). It is noted that the entirety of the rear face does not need to physically engage or otherwise interface with the pressure source. Rather, it is the region at the rear face that is defined by the plurality if liquid conduits that is operably attached to (or engaged by) the pressure source. The operable attachment of the rear face of the dispensing head and the pressure source can be achieved in any convenient manner. In certain embodiments, the rear face of the dispensing head includes one or more structural features configured to engage complementary structural features on the pressure source and that facilitate the operable attachment of the pressure source to the rear face. Examples of such structural features include, but are not limited to: alignment structures (e.g., nodes, pins, grooves, holes, etc.), attachment structures (e.g., magnets, clasps, releasable locking pins, screws, etc.), sealing structures for producing an air-tight seal between the rear face and the pressure source (e.g., gaskets, grooves for seating gaskets, smooth region for engaging a gasket, etc.).

The size of a dispensing head according to aspect of the present disclosure can vary and will depend on the application and system in which it is to be used. In certain embodiments, a dispensing head can be from about 8.00 mm to about 50.00 mm in thickness, from about 20.00 mm to about 100.00 mm wide, and from about 50.00 to about 200.00 mm in length.

In certain embodiments, a composite liquid cell handling system includes a plurality of dispensing heads, i.e., at least two or more, e.g., 3, 4, 5, 6, 7, 8, 9, 10, 15, 20 dispensing head or more. In such embodiments, the plurality of dispensing heads can have substantially the same configuration, e.g., number and spacing of conduits, while in other embodiments the plurality of dispensing heads includes at least one dispensing head that has a substantially different configuration. No limitation in this regard is intended.

### SPECIFIC EMBODIMENTS

Provided below are specific examples of dispensing heads according to aspects of the present disclosure.

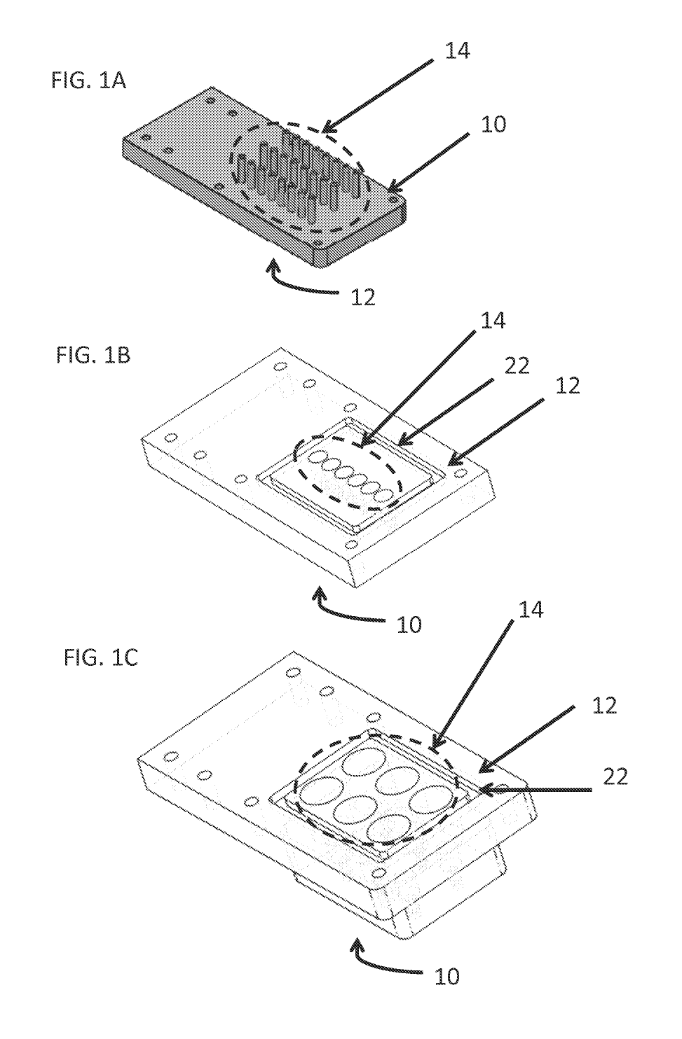

FIG. 1 provides three examples of a dispensing head according to aspects of the present disclosure. Panel A of FIG. 1 shows a dispensing head having a dispensing face 10, a rear face 12 opposite the dispensing face (unseen in this panel), and 24 conduits in a 3×8 array 14. As described herein, each conduit provides a pathway for fluid communication between the rear face 12 and the dispensing face 10. Panel B of FIG. 1 shows a dispensing head having a rear face 12, a dispensing face 10 opposite the dispensing face (unseen in this panel), and 6 conduits arranged linearly (or in-line). The rear face of the dispensing head also includes a groove 22 around the conduits configured seat a gasket for creating an air-tight/fluid tight seal with a pressure source when operably attached. In certain embodiments, for example, a gasket designed to fit this groove is placed therein which forms an air-tight/fluid tight seal when the pressure source engages the dispensing head. Panel C of FIG. 1 shows a dispensing head having a rear face 12, a dispensing face 10 opposite the dispensing face (unseen in this panel), and 6 conduits in a 2×3 array 14. The rear face of the dispensing head also includes a groove 22 around the conduits configured to assist in creating an air-tight/fluid tight seal with a pressure source when engaged therewith. In certain embodiments, for example, a gasket designed to fit this groove is placed therein which forms an air-tight/fluid tight seal when the pressure source engages the dispensing head.

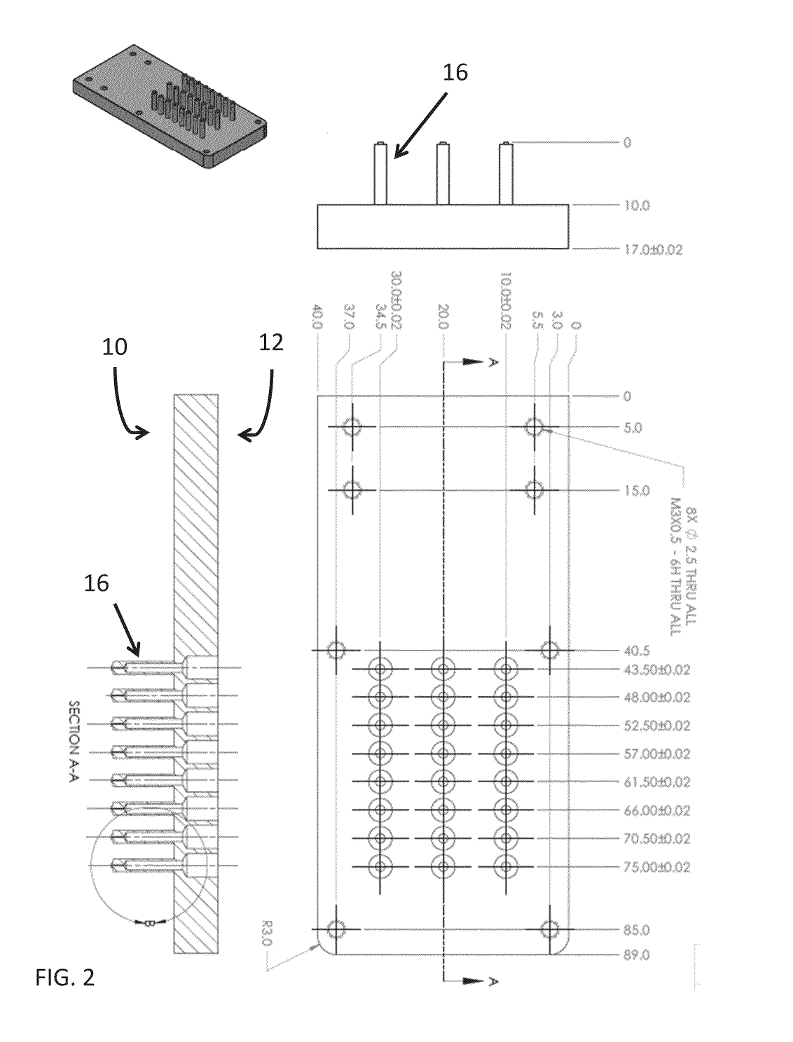

FIG. 2 provides further details of the dispensing head shown in FIG. 1A, which has a 3×8 array of 24 conduits and is reproduced at the top left of FIG. 2. The dimensions shown are in millimeters (mm) Three different views are shown of this dispensing head. The schematic at the bottom right of FIG. 2 shows the view from the dispensing face of the dispensing head, the schematic at the top right shows the view from along the short edge of the dispensing head, and the schematic at the bottom left shows the view from along section A-A through the middle of the center column of conduits of the dispensing head. In the later schematic, the dispensing face 10 and the rear face 12 are indicated. The part of the conduit adjacent to the dispensing face 10 is indicated in the top right and bottom left schematics as element 16.

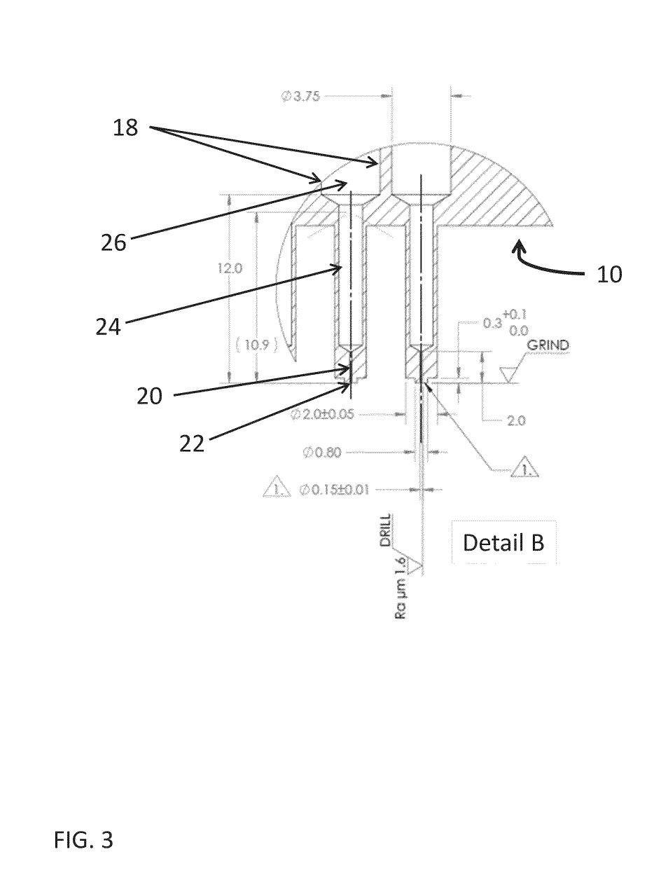

FIG. 3 shows a detailed view of area B shown in FIG. 2, bottom left schematic. As in FIG. 2, all dimensions are in mm. In FIG. 3, the internal wall of the liquid conduit 18 defines the path a liquid can take through the liquid conduit. The liquid conduit is shown as including a protrusion from dispensing face 10 that is about 10 mm. The path in the liquid conduit includes a capillary region 20 having an opening 22 through which a liquid is aspirated into or dispensed out of the liquid conduit in response to a pressure provided by the pressure source at the rear face (not shown). In FIG. 3, the capillary region is a cylindrical region that is 2.0 mm in height and that has a diameter of 0.15 mm±0.01 mm. The path in the liquid conduit shown in FIG. 3 includes other regions 24 and 26 that have different diameters and that can hold a volume of liquid during operation as desired, for example during dispensing operations in which the liquid in the conduit is dispensed into multiple different locations without refilling in between dispensing actions. In this example, the other regions can be considered liquid reservoirs for the liquid conduit. It is noted that at certain times during operation the liquid conduit may not contain a liquid, e.g., after completely dispensing the liquid therein.

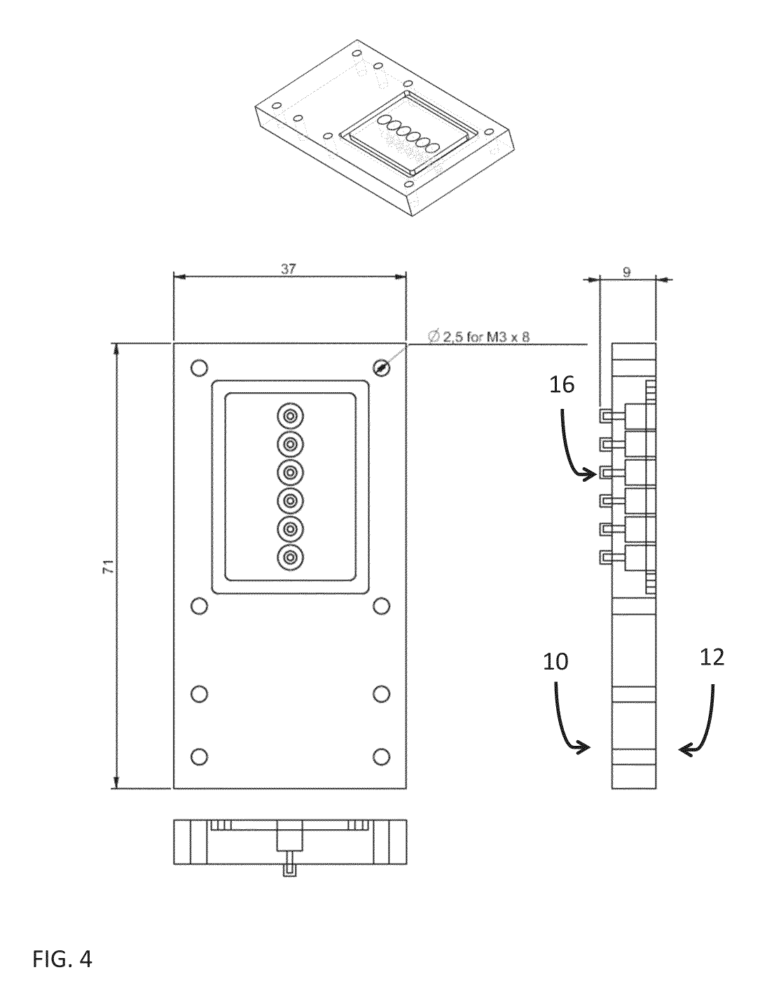

FIG. 4 provides further details of the dispensing head shown in FIG. 1B, which has a liner arrangement of 6 conduits and is reproduced at the top left of FIG. 4. The dimensions shown are in millimeters (mm) Three different views are shown of this dispensing head. The schematic at the top left of FIG. 4 shows the view from the dispensing face of the dispensing head, the schematic at the bottom left shows the view from along the short edge of the dispensing head, and the schematic at the right shows the view from along the long edge of the dispensing head. In this figure, the rendering of the dispensing head in the bottom three drawings is providing a transparent view, allowing all features of the dispensing head to be seen in all three orientations. The dispensing face 10, the rear face 12, and the part of the conduit adjacent to the dispensing face 16 are indicated in the right schematic.

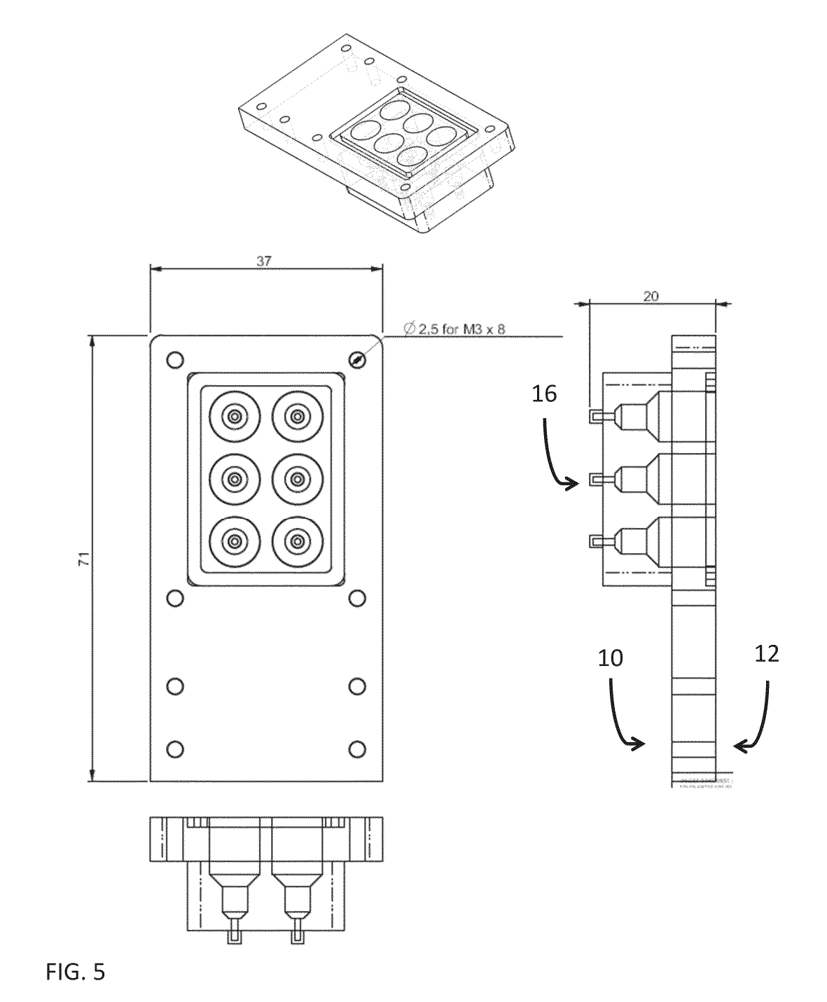

FIG. 5 provides further details of the dispensing head shown in FIG. 1C, which has a 2×3 array of 6 conduits and is reproduced at the top left of FIG. 5. The dimensions shown are in millimeters (mm) Three different views are shown of this dispensing head. The schematic at the top left of FIG. 5 shows the view from the dispensing face of the dispensing head, the schematic at the bottom left shows the view from along the short edge of the dispensing head, and the schematic at the right shows the view from along the long edge of the dispensing head. In this figure, the rendering of the dispensing head in the bottom three drawings is providing a transparent view, allowing all features of the dispensing head to be seen in all three orientations. The dispensing face 10, the rear face 12, and the part of the conduit adjacent to the dispensing face 16 are indicated in the right schematic.

Pressure Source

As noted above, a composite liquid cell handling system according to aspects of the disclosure can also include a pressure source that can be operably attached to the dispensing head and configured to modulate the pressure at the rear face of the dispensing head, and thereby in the liquid conduit/plurality of liquid conduits collectively. The pressure source can modulate the pressure of the liquid conduit(s) using any convenient gas, e.g., air. Application of positive pressure from the pressure source can be used to drive out liquid present in the liquid conduit(s) at the dispensing face side. As detailed below, a desired amount of a liquid can be dispensed from each liquid conduit(s) by applying a determined pressure at the rear face of the dispensing head for a determined interval (amount of time), taking into consideration the properties of the liquid (e.g., viscosity, temperature, etc.). The amount of liquid dispensed is generally determined by the user of the system and can be anywhere from nanoliters (nL) to milliliters (mL). The maximum amount dispensed from a conduit at a single dispensing operation will be limited by the liquid holding capacity of the dispensing head. Application of negative pressure from the pressure source can be used to draw liquid into the liquid conduit(s) (also referred to as aspirating) at the dispensing face side when the opening of the conduits are in contact with a liquid of interest. When aspirating using a plurality of liquid conduits, all of the plurality of conduits can be in contact with the same liquid, e.g., in a bulk reagent well, or each conduit (or a subset of conduits) can be in contact with a different sample, e.g., multiple different samples present in the wells of a multi-well plate.

Transporter

As summarized above, devices described herein include a transporter configured to translate the dispensing head to any of a plurality of locations in the system. For example, the transporter can be configured to translate the dispensing head to sample wells, reagent wells, and CLC reaction location(s), etc. The transporter can be robotically controlled to move the dispensing head between at least two distinct locations of the system, such as a sample or reagent well and a CLC reaction well. Transporters thus allow a dispensing head to aspirate a defined volume of liquid from a first location of the device and deposit a defined volume of liquid at second location of the device. Note that the defined volume aspirated and the defined volume deposited need not be identical (e.g., the dispensing head can aspirate a volume greater that the amount dispensed). While the volume of liquid that the dispensing head is configured to transfer may vary, in some instances the volume ranges from 100 nL to 10 mL, such as 100 nL to 1 mL. The transporter can also include an actuator to move the dispensing head between locations.

In embodiments in which the composite liquid cell handling system comprises a plurality of dispensing heads (as noted above), the transporter can further be configured to operably attach any one of the plurality dispensing heads to the pressure source as well as remove from operable attachment to the pressure source a dispensing head operably attached thereto.

Further details regarding transporters that may be employed in the system are provided in PCT application Serial No. PCT/IB2013/003145 published as WO 2014/08345; the disclosure of which is herein incorporated by reference.

Controller

The composite liquid cell handling systems disclosed herein can further include a controller, e.g., a computer controller, for operating the components of the system. In some embodiments, the controller is operably attached to the pressure source and configured to cause the pressure source to modulate pressure at the rear face of the dispensing head, e.g., to aspirate and/or dispense a liquid. The controller can also be operably attached to the transporter (or the actuator of the transporter) and configured to cause the transporter to perform any one of the following: translate a dispensing head to a location in the system, move a dispensing head between at least two distinct locations of the system, move the dispensing head in a desired pattern, cause the transporter to operably attach the pressure source to a dispensing head, cause the transporter to disengage the pressure source from a dispensing head.

In certain embodiments, the controller of the system further includes an input device (or input module) for receiving signals used to run a liquid dispensing operation. The input manager is configured to receive labelled biomolecule requests from a single user or a plurality of different users, such as 2 or more different users, such as 5 or more different users, such as 10 or more different users, such as 25 or more different users and including 100 or more different users. In certain embodiments, the input device is configured to receive a signal (e.g., from a user) and, based on this signal, determine a pressure and time interval to apply to the rear face of a dispensing head in the system and then cause the pressure source to apply the determined pressure for the determined time interval to the rear face of the dispensing head. The signal received by the input device can include, but is not limited to, a predetermined dispensing quantity of liquid, a predetermined viscosity of a liquid, a predetermined volume of each liquid conduit, and any combination thereof. In such embodiments, the controller can be programmed to determine the pressure and time interval such that, if the determined pressure were applied to the rear face for a time equal to the determined time interval, and each of the conduits was charged with at least the predetermined volume of a liquid having the predetermined viscosity, the predetermined quantity of the liquid would be dispensed from each conduit at the dispensing face. Therefore, in response to receiving at the input device signals representative of (i) a predetermined dispensing quantity of liquid, (ii) a predetermined viscosity, and (iii) a predetermined volume of each liquid conduit, the controller can determine a paired pressure and time interval that if applied to the rear face for a time equal to the determined time interval (and each of the conduits was charged with at least the predetermined volume of a liquid having the predetermined viscosity), the predetermined quantity of the liquid would be dispensed from each conduit at the dispensing face. The controller can then cause the pressure source to apply the determined pressure to the rear face for a time equal to the determined time interval.

In some embodiments, the signal received by the input device includes a predetermined pressure and time interval, and thus the controller need not have to determine these parameters itself but merely use them in a liquid dispensing protocol.

A typical program might first move the distal end of the conduits of a dispensing head into contact with a liquid sample (or samples), draw the sample(s) into the plurality of conduits, then move the dispensing head so that the distal end of the conduits are adjacent to dispensing locations, and finally apply sufficient positive pressure to the rear face of the dispensing head to eject a predetermined volume of liquid from the distal end of the plurality of conduits of the dispensing head.

In some embodiments, the input device may include, for example, a keyboard, mouse, touchscreen, graphical user interface (GUI), or the like for input of signals by a user/operator of the system. In one example, the GUI includes a drop-down menu to input a dispensing operation by selecting one or more options from a drop-down menu. In another example, the graphical user interface includes a first drop-down menu to input a first operation and a second drop-down menu to input a second operation by selecting one or more options from the first and second drop-down menus.

The controller can include one or more processing modules and, in some embodiments, an output module. The processing module includes a processor which has access to a memory having instructions stored thereon for performing the steps of the subject methods. Processing modules of the subject systems include both hardware and software components, where the hardware components may take the form of one or more platforms, e.g., in the form of servers, such that the functional elements, i.e., those elements of the system that carry out specific tasks (such as managing input and output of information, processing information, etc.) of the system may be carried out by the execution of software applications on and across the one or more computer platforms represented of the system. The one or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include WINDOWS NT®, Sun Solaris, Linux, OS/400, Compaq Tru64 Unix, SGI IRIX, Siemens Reliant Unix, and others. Other development products, such as the Java™2 platform from Sun Microsystems, Inc. may be employed in processors of the subject systems to provide suites of applications programming interfaces (API's) that, among other things, enhance the implementation of scalable and secure components. Various other software development approaches or architectures may be used to implement the functional elements of system and their interconnection, as will be appreciated by those of ordinary skill in the art.

Output modules of the controller may include any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via system bus. Some of these communications may be accomplished in alternative embodiments using network or other types of remote communications. The output module may also provide information generated by the processing module to a user at a remote location, e.g., over the Internet, phone or satellite network, in accordance with known techniques. The presentation of data by the output modules may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located or they may be physically separated. Various operating systems may be employed on any of the computer platforms, possibly depending on the type and/or make of computer platform chosen. Appropriate operating systems include Windows NT™, Windows XP, Windows 7, Windows 8, iOS, Sun Solaris, Linux, OS/400, Compaq Tru64 Unix, SGI IRIX, Siemens Reliant Unix, and others.

The system memory may be any of a variety of known or future memory storage devices. Examples include any commonly available random access memory (RAM), magnetic medium such as a resident hard disk or tape, an optical medium such as a read and write compact disc, flash memory devices, or other memory storage device. The memory storage device may be any of a variety of known or future devices, including a compact disk drive, a tape drive, a removable hard disk drive, or a diskette drive. Such types of memory storage devices typically read from, and/or write to, a program storage medium (not shown) such as, respectively, a compact disk, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor the computer, causes the processor to perform a composite liquid cell-based protocol, e.g., a nucleic acid library production protocol, a biological assay protocol, etc, as described herein. In other embodiments, some functions are implemented primarily in hardware using, for example, a hardware state machine. Implementation of the hardware state machine so as to perform a composite liquid cell-based protocol as described herein will be apparent to those skilled in the relevant arts.

Memory may be any suitable device in which the processor can store and retrieve data, such as magnetic, optical, or solid state storage devices (including magnetic or optical disks or tape or RAM, or any other suitable device, either fixed or portable). The processor may include a general purpose digital microprocessor suitably programmed from a computer readable medium carrying necessary program code. Programming can be provided remotely to the processor through a communication channel, or previously saved in a computer program product such as memory or some other portable or fixed computer readable storage medium using any of those devices in connection with memory. For example, a magnetic or optical disk may carry the programming, and can be read by a disk writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The processor may also have access to a communication channel to communicate with a user at a remote location. By remote location is meant the user is not directly in contact with the system and relays input information to an input module from an external device, such as a computer connected to a Wide Area Network (“WAN”), telephone network, satellite network, or any other suitable communication channel, including a mobile telephone (i.e., smartphone).

In some embodiments, a controller according to the present disclosure may be configured to include a communication interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, WiFi, infrared, wireless Universal Serial Bus (USB), Ultra Wide Band (UWB), Bluetooth® communication protocols, and cellular communication, such as code division multiple access (CDMA) or Global System for Mobile communications (GSM).

Additional Components

Thermal Chip Module

In certain embodiments, the systems described herein include a thermal chip module. Thermal chip modules are plate or chip type structures that include one or more nodes (or well locations) that are configured to hold CLCs, CLC samples, and/or CLC reactions, e.g., from 1 to 5,000 nodes, including 10 to about 1,000 nodes or 1 to 100 nodes, e.g., 15 nodes, 20 nodes, 30 nodes, 40 nodes, 48 nodes, 96 nodes, 384 nodes, etc. The volume defined by a given node/well may vary, and in some instances ranges from 2 μl to 1 mL, such as 5 μl to 20 μl.

An aspect of the thermal chip modules is that they are thermally controlled, such that the temperature of the environment defined by each node (and therefore experienced by a CLC reaction well therein) may be controlled, e.g., including precisely controlled, e.g., to a tenth of degree or better. The range of temperature control may vary, where in some instances the temperature may be controlled between 4 to 120° C., such as 4 to 98° C. To provide for thermal control, the thermal chip module may include heating and/or cooling elements. For example, the thermal chip module may include a cooling region configured to be operably attached to temperature modulator, e.g., a thermoelectric module, a fluidic cooling system or a forced convection cooling system. The chip module may also include a heating element, for example, an etched foil heater electrically connected to a controller, the controller being programmed to activate the heating element to generate a desired thermocycle in the CLCs accommodated therein. The thermal chip module can also be operatively coupled to a lid sized and shaped to mate with the module or portion thereof so as to enclose the nodes/wells and any CLCs accommodated therein. The lid may be openable and closeable by an automatic actuator, or may be manually operated. The lid can seal the carrier liquid into the vessel in order to inhibit evaporation of the carrier liquid. The lid can partially seal against the vessel, or it can be substantially airtight, maintaining a pressure seal. The lid can be transparent to any particularly desired wavelength of light, to allow for electromagnetic interrogation of the CLCs. A heating element can be included in the lid, as desired. The lid can be thermally controlled as desired, such that the temperature of the lid may be modulated to a desired value.

Sample and Reagent Receiving Locations

Systems can include sample and reagent receiving locations configured to receive plates, wells, or reservoirs that include liquids that are to be manipulated by the composite liquid cell handling systems of the present disclosure. In certain embodiments, a receiving location accommodates a multiplex storage system, e.g., a multi-well plate, whereas in other embodiments, the receiving location is configured to receive a reservoir, e.g., a bulk reagent reservoir, that can be accessed by the dispensing head(s) of the system for aspiration/dispensing operations. Receiving locations are configured to receive samples and/or assay reagents (e.g., master mix reagents) in and desired format. Samples can include any sample of interest, including biological samples, e.g., nucleic acid samples, protein samples, blood samples, etc. By assay reagents is meant reagents that are specific to a particular assay (e.g., sequence specific primers, adapters, etc.). By master mix reagents is meant reagents that can be used in multiple different assays (e.g., enzymes, buffers, universal primers, etc.). In certain embodiments, the assay and/or master mix reagents are provided as bulk solutions, e.g., in reagent baths, whereas in other embodiments they are provided in industry standard plates (e.g., 96 well, 384 well, etc.). The receiving locations can be configured to receive one or multiple samples or assay reagents at a time.

While the number of receiving locations present in the system may vary, in some instances the system includes 1 to 100 receiving locations, such as 10 to 80 receiving locations, e.g., 50 receiving locations. The receiving location(s) may be arranged in any convenient manner in the system, where in some instances in which the system includes a plurality of receiving locations, the plurality of receiving locations are arranged adjacent to each other, e.g., in a portrait format relative to an entry port of the system. Receiving locations are regions or areas of the system configured to hold a laboratory plate, such as a multi-well plate, e.g., a 96 or 384 multi-well plate, or analogous structure, e.g., a test tube holder or rack, etc. A given receiving location may be a simple stage or support configured to hold a laboratory plate. While the dimensions of the receiving locations may vary, in some instances the receiving locations will have a planar surface configured to stably associate with a desired liquid holding device, e.g., a laboratory plate, where the planar surface may have an area ranging from 10 mm to 400 mm, such as 10 mm to 200 mm. The planar surface may have any convenient shape, e.g., circular, rectangular (including square), triangular, oval, etc., as desired. To provide for stable association between a receiving location and a desired liquid holding device, the receiving location may include one or more stable association elements, e.g., clips, alignment posts, etc.

In some instances, the receiving location may be thermally modulated, by which is meant that the temperature of the plate location may be controllable. Any convenient temperature modulator may be employed to control the temperature of the receiving location in a desired manner, where temperature modulators that may be employed include those described above in connection with the thermal chip module.

In some instances, a given receiving location may be configured to be agitated, i.e., the receiving location is a shaker unit. As such, it may include an agitator (e.g., vibrator or shaker component). While the frequency of the movement of the receiving location provided by the agitator component may vary, in some instances that agitator may be configured to move the receiving location between first and second positions at a frequency ranging from 1 rpm to 4000 rpm, such as 50 rpm to 2500 rpm, where the distance between the first and second positions may vary, and in some instances ranges from 10 mm to 400 mm, such as 25 mm to 100 mm.

Bulk Reagent Reservoir

In certain embodiments, systems described herein include a bulk reagent reservoir. The bulk reagent reservoir includes one or more additional reagents used in a desired composite liquid cell handling operation, e.g., carrier fluid, encapsulating fluid, etc., where the system is further configured to transfer liquid between the bulk reagent reservoir and other locations within the system to dispense a liquid reagent composition at a desired location, e.g., a CLC reagent well on the thermal chip module.

Fluidics Module

The systems described herein may include a fluidics module that includes one or more liquid reservoirs, e.g., for system fluids, waste collection, etc. System fluids of interest include, but are not limited to, wash fluids, elution fluids, etc. Where desired, the waste collection reservoir is operatively coupled to a single waste drain.

Composite Liquid Cell Processing Method

The present disclosure provides methods for processing composite liquid cell reactions in a composite liquid cell handling system as described herein. The methods can be for performing any of a variety of different composite liquid cell based assays, manipulations, or reactions, including but not limited to nucleic acid library preparation, analyte detection assays, genotyping assays, enrichment or purification of a component in a biological sample, labeling of an analyte, amplification of a polynucleotide, etc.

In certain embodiments, the system employed in the methods includes a dispensing head according to the present disclosure. Thus, in certain embodiments, the dispensing head has a rear face, a dispensing face disposed on the dispensing head opposite the rear face, and liquid conduit(s) providing a pathway for fluid communication between the rear face and the dispensing face. Specific examples of dispensing heads are shown in FIGS. 1 to 5 and described elsewhere herein. The system further includes a pressure source that can be operably attached to the dispensing head and configured to modulate pressure at the rear face and thereby in the liquid conduits collectively. The pressure at the rear face can be modulated in a manner desired by a user and includes applying a negative pressure for aspiration of a liquid, a positive pressure for dispensing a liquid, and a substantially neutral pressure to maintain a liquid at a constant level in the liquid conduit. In many embodiments, the system includes a controller that is operably attached to the pressure source and configured to cause the pressure source to modulate pressure to the rear face in a specified manner. The controller can have an input device/module for receiving signals that are used by the controller to control the pressure source.

In some embodiments, the method includes receiving a signal at the input device; determining in the controller a pressure and time interval based on the signal; and applying with the pressure source the determined pressure for the determined time interval to the rear face of the dispensing head. The signal received can include any type of information related to the functioning of the pressure source, including but not limited to information selected from the group consisting of: (i) a predetermined dispensing quantity of liquid, (ii) a predetermined viscosity, (iii) a predetermined volume of each liquid conduit, and combinations thereof. The pressure and time interval are determined by the controller such that, if the determined pressure were applied to the rear face for a time equal to the determined time interval, and the conduit(s) was charged with at least the predetermined volume of a liquid having the predetermined viscosity, the predetermined quantity of the liquid would be dispensed from each conduit at the dispensing face. When the predetermined dispensing quantity is positive, the determined pressure is positive, thus prompting the controller to cause the pressure source to apply the determined pressure to expel (dispense) substantially the predetermined quantity of the liquid from the liquid conduit(s). When the predetermined dispensing quantity is negative, the determined pressure is negative, thus prompting the controller to cause the pressure source to apply the determined pressure to aspirate substantially the predetermined quantity of the liquid into the liquid conduit(s).

In some embodiments, the signals received by the input device includes precise instructions for modulating the pressure source that do not need any computational manipulation by the controller, e.g., a series of pressure modulating steps each of which includes applying a specific pressure at the rear face of the dispensing head for a specific time interval to effect aspiration (negative pressure), holding (substantially neutral pressure), and dispensing (positive pressure) operations of the dispensing head.

In order to perform liquid manipulation functions, the system often includes a transporter configured to translate the dispensing head to any of a plurality of locations in the system. As such, in many embodiments the method further includes translating the dispensing head to any of a plurality of locations with the transporter prior to executing the desired operation (e.g., aspirating or dispensing actions). Locations include sample plate/well locations, reagent plate/well locations (e.g., for sample specific and multiplex assay reagents), bulk fluid reservoirs (e.g., for carrier fluid, encapsulating fluid, wash/rinse fluids), etc.

As one example, the method can include translating the dispensing head with the transporter to a location where the dispensing face is in contact with a liquid; with the controller, causing the pressure source to apply a negative pressure, for a specific interval, to the rear face of the dispensing head, thereby aspirating an amount of the liquid through the dispensing face into each of the liquid conduits; translating the dispensing head with the transporter to a dispensing location (e.g., while the pressure source applies a substantially neutral pressure to hold the fluid in the liquid conduits while being transported); and with the controller, causing the pressure source to apply a positive pressure to the rear face of the dispensing head, thereby dispensing at least a portion of the aspirated liquid through the dispensing face from the liquid conduit(s) at the dispensing location, e.g., where the dispensing head comprises a plurality of liquid conduits, the head can dispense the liquid from each of the plurality of liquid conduits into corresponding wells of a multi-well receptacle. In some cases, after the first dispensing operation, the dispensing head still contains a sufficient amount fluid in the liquid conduits to perform a second dispensing operation. As such, after the first aspiration operation and the first dispensing operation, the dispensing head can be translated to a second dispensing location to dispense an amount of liquid therefrom (i.e., a second dispensing operation) without having to perform a second aspirating operation. The number of dispensing operations that can be performed after a single aspiration operation will depend on the capacity of the liquid conduits in the dispensing head and the amount of liquid dispensed in each dispensing operation, which may be the same amount dispensed in each dispensing operation or may include a least one dispensing operation that dispenses a different amount of liquid than at least one other dispensing operation. No limitation in this regard is intended. It is further noted that in some embodiments, a dispensing head is provided to the system already containing a liquid in the plurality of liquid conduits, and thus an aspiration operation is not required before performing the first dispensing operation.

In certain embodiments, the composite liquid cell handling system includes a plurality of dispensing heads, e.g., two or more, three or more, four or more, five or more, ten or more, 20 or more, 30 or more, 40 or more, 50 or more, etc. In such embodiments, the transporter is capable of operably attaching any one of the plurality dispensing heads to the pressure source as well as removing an operably attached dispensing head from the pressure source. When a system includes multiple dispensing heads, the methods can include operably attaching the pressure source via the transporter to a first dispensing head, operating the first dispensing head using the controller to perform a first liquid dispensing operation, removing the first dispensing head from the pressure source via the transporter, operably attaching the pressure source via the transporter to a second dispensing head, and operating the second dispensing head using the controller to perform a second liquid dispensing operation. In certain embodiments, an aspiration operation is performed prior to the dispensing operation with the first and/or second dispensing head. As such, the method also can include translation of an operably attached dispensing head using the transporter to an aspirating location and then to a dispensing location in the system, as described above. This process can be repeated using a third dispensing head to perform a third dispensing operation, a fourth dispensing head to perform a fourth dispensing operation, a fifth dispensing head to perform a fifth dispensing operation, a sixth dispensing head to perform a sixth dispensing operation, etc., as desired by a user.

Where multiple dispensing heads are employed, the system can be controlled to use virtually any combination of dispensing heads to manipulate multiple different liquids present in the system, e.g., samples, assay/reaction specific reagents, bulk reagents, etc., to generate a desired composite liquid cell reaction. As such, a single dispensing head can be used to dispense a liquid at one or more locations during a liquid manipulation program in only a single step in the program or, alternatively, at multiple different steps in the program. In addition, a single dispensing head can be used to dispense only a single type of liquid or may be used to dispense multiple different liquids, e.g., after being run through a wash step. In certain embodiments, the liquid dispensed from a first dispensing head in a first dispensing operation and the liquid dispensed from a second dispensing head in a second dispensing operation are dispensed at the same location, e.g., to produce a composite liquid cell (CLC) from a carrier fluid, an encapsulating fluid, and an aqueous sample (each of which fluids are immiscible in the other two). In other embodiments, the liquids are dispensed at different locations (e.g., when using different dispensing heads to transfer samples from a multi-well sample plate to a multi-well receptacle, e.g., at the thermal chip module. Where a liquid manipulation program repeated for multiple cycles, the liquids can be dispensed at a different location in each cycle, e.g., when the system is used to perform sequential CLC reactions from a plurality of multi-well sample plates.

The configuration and use of dispensing heads in the system can be determined by a user, and as such, no limitation in this regard is intended.

While the systems described herein can be used in methods for manipulating virtually any combination of different liquids, methods according to certain aspect of the present disclosure include composite liquid cell handling processes. Examples include generating a plurality of composite liquid cells (CLCs), e.g., at nodes or self-contained wells of a thermal chip module, as well as using such CLCs for processing a biological sample. In certain embodiments, the biological sample processing includes, but is not limited to: biological sample preparation, biological sample purification, analyte detection, nucleic acid amplification, nucleic acid cleavage, nucleic acid hybridization, nucleic acid ligation, and any combination thereof. For example, biological sample processing can be for generating a library of nucleic acids from a nucleic acid sample, or for sample analysis/analyte detection, e.g., a genotyping assay.

As but one example, the systems described herein can be used to prepare nucleic acid libraries for next generation sequencing (NGS). In brief, one or more nucleic acid sample is provided to the system (e.g., in a multi-well plate) along with one or more consumable reagents (e.g., buffers, enzymes, adapters, purification magnetic beads, bulk reagent reservoirs, wash and purification fluids, etc.) needed to generate a nucleic acid library from each of the samples. Control instructions and data about a given run can be input into the system, e.g., by using an automated protocol (such as with a hand held barcode scanner) or manually via an appropriate user interface, etc. Control instructions can include information regarding the number and type of dispensing heads, the liquids to be dispensed by each dispensing head, the volume and location to aspirate and dispense, the viscosity of each liquid, the number of cycles, etc., which may be input using any convenient protocol, e.g., via manually entered user data or a previously generated.csv file. The system can include a main user interface which can in some embodiments provide feedback for run status information. The system may further include a web services component, e.g., which is configured to monitor status and generate an email to be sent in the event of a critical error. The system may also be configured to produce an output file: e.g., which may include a barcoding file, and a library definition file, where such files can be optionally amalgamated into one. The name of the run log folder may be included in the output file as well as the protocol that was run. Run logs may be numbered to keep them in order. The system may be configured to guide a user during setup.

Once the system is loaded with nucleic acid sample(s) and configured for a given NGS library production run, the run is started. During the run, the system accesses reagent first dispensing head via the transporter to transfer a suitable volume of nucleic acid sample, e.g., 1 nL to 1 mL, such as 1 nl to 50 uL, e.g., 100 nL to 50 uL, from one or more sample wells to a CLC reaction well of the thermal chip module. In some embodiments, the sample well in the sample cartridge had carrier and encapsulating fluids therein, such that a CLC was formed when the sample was added to the well, and thus a CLC is formed in the CLC reaction well upon transfer. In other embodiments, the carrier and/or encapsulating fluids are placed into the well by the system before the dispensing the nucleic acid sample. Details regarding CLC production methods which may be employed by the system are further described in U.S. Pat. No. 8,465,707, the disclosure of which is herein incorporated by reference.

Following production of sample containing CLC reaction(s) in corresponding CLC reaction well(s), e.g., from one or more corresponding samples, at the thermal chip module(s), the system sequentially engages a second, third, and/or fourth, etc., dispensing heads as needed to dispense reagents as desired into each CLC reaction well. Each reagent may be sequentially added to CLCs, or two or more reagents may be pre-combined and added to the CLCs, as desired. Following reagent addition to the CLCs in the CLC reaction wells, the thermal chip module(s) may be subjected to temperature modulation, e.g., in the form of thermal cycling, as desired for a given NGS library preparation protocol.

At any step during the process, generally where dictated by the nature of the library production protocol, sample identifiers, e.g., nucleic acid barcodes, may be added to the CLC reaction wells and ligated to the nucleic acids therein to uniquely identify the nucleic acids in each CLC reaction well according to the sample source.

Following production of the barcoded nucleic acid libraries in the CLCs of the CLC reaction wells in the CLC reaction cartridge present on the thermal chip module(s), the resultant barcoded nucleic acid libraries may be purified to produce a product NGS library suitable for use in an NGS sequencing protocol. While the resultant barcoded libraries may be purified using any convenient protocol, in some instances a magnetic bead based purification protocol is employed. Details regarding magnetic bead/conduit based purification protocols that may be employed by the system are further described in PCT Application Serial No. PCT/IB2014/002159 published as WO 2014/207577; the disclosure of which is herein incorporated by reference.

The resultant product NGS libraries may then be sequenced, as desired, using any convenient NGS sequencing platform, including: the HiSeg™, MiSeg™ and Genome Analyzer™ sequencing systems from Illumina®; the Ion PGM™ and Ion Proton™ sequencing systems from Ion Torrent™; the PACBIO RS II sequencing system from Pacific Biosciences, the SOLiD sequencing systems from Life Technologies™, the 454 GS FLX+ and GS Junior sequencing systems from Roche, or any other convenient sequencing platform.

Reference is made to the following patent publications which provide descriptions of certain components of composite liquid cell handling systems and methods of use thereof: U.S. Pat. Nos. 8,465,707 and 9,080,208; United States Patent Application Publication No. 20140371107; U.S. Provisional Patent Application Ser. Nos. 61/590,499, 61/730,336, 61/836,461, 61/908,473, 61/908,479, and 61/908,489; International Patent Application Ser. Nos. PCT/US2013/023161, PCT/US2013/071889, PCT/IB2015/055903, PCT/IB2015/055902, and PCT/IB2015/055904; Published PCT Application Nos: WO2014/083435; WO2014/188281; WO2014/207577; WO2015/075563; WO2015/075560. The disclosures of each are hereby incorporated by reference herein.

Use of a Composite Liquid Cell Handling System

Certain aspects of the present disclosure are drawn to use of a CLC handling system as described herein, e.g., by a user.

In some embodiments, use of a CLC system as described herein includes inputting a signal at the input device/module of a CLC handling system that relates to at least one dispensing operation such that the system performs the dispensing operation. In certain embodiments, the controller of the system receives the signal and uses it to determine a pressure and time interval that is then applied with the pressure source to the rear face of the dispensing head, thereby performing the dispensing operation. The signal input into the system can include any type of information related to the functioning of the pressure source, including but not limited to information selected from the group consisting of: (i) a predetermined dispensing quantity of liquid, (ii) a predetermined viscosity, (iii) a predetermined volume of each liquid conduit, and combinations thereof. As discussed above, the controller is programmed to determine the necessary pressure and time interval to apply to the rear face of the dispensing head to dispense the predetermined quantity of the liquid from the conduit(s) when charged with at least the predetermined volume of a liquid having the predetermined viscosity. When the predetermined dispensing quantity is positive, the determined pressure is positive, thus prompting the controller to cause the pressure source to apply the determined pressure to expel (dispense) substantially the predetermined quantity of the liquid from the liquid conduit(s). When the predetermined dispensing quantity is negative, the determined pressure is negative, thus prompting the controller to cause the pressure source to apply the determined pressure to aspirate substantially the predetermined quantity of the liquid into the liquid conduit(s).

In some embodiments, the signals input by a user by of the system includes precise instructions for modulating the pressure source that do not need any computational manipulation by the controller, e.g., a series of pressure modulating steps each of which includes applying a specific pressure at the rear face of the dispensing head for a specific time interval to effect aspiration (negative pressure), holding (substantially neutral pressure), and dispensing (positive pressure) operations of the dispensing head.

As described herein, the system can include a transporter for engaging dispensing heads and transporting them to desired locations for aspiration and dispensing operations. Thus, in certain embodiments, the signal(s) input by the user can include information regarding the movement and functioning of the transporter of the system that are needed to perform liquid manipulation/dispensing functions that are desired by the user. Alternatively, or in addition, the controller can be pre-programmed to perform certain transporter operations based on non-transporter-specific signals input by a user. For example, a user can input a signal to generate and perform one or more PCR reactions into a system in which the location and amount of a bulk reagent or master-mix has already been pre-programmed into the system (i.e., these reagents are in predetermined locations in the system). Signals input by a user or pre-programmed into a system that are related to transporter actions may include location information, sample plate/well locations (e.g., thermal plate module location and well configuration), reagent plate/well locations (e.g., for sample specific and multiplex assay reagents), bulk fluid reservoirs (e.g., for carrier fluid, encapsulating fluid, wash/rinse fluids), etc.

It is noted here that any combination of user-input signals/information and pre-programmed signals/information may be used to control a system of the present disclosure to perform a dispensing operation as desired. While examples of CLC processing methods are describe in detail in the previous section (e.g., using multiple liquids at multiple locations and multiple dispensing heads), specific examples are provided below.

In certain embodiments, a system is programmed (with user input signals, pre-programmed information, or a combination thereof) to perform a biological sample processing operation. Examples include: generating one or more libraries of nucleic acids from one or more nucleic acid samples, purifying or detecting one or more analytes in one or more samples (e.g., a genotyping assay or an assay to detect a protein of interest), performing one or more polynucleotide amplification reactions in one of more samples, etc.

In one embodiment, the systems described herein are programmed to prepare nucleic acid libraries for next generation sequencing (NGS) from multiple nucleic acid samples. In brief, the program controls the system to access and aspirate one or more nucleic acid samples (e.g., in a multi-well plate) at a sample location in the system with a first dispensing head in the system using the transporter. In this step, the program may include instructions controlling the system to engage a specific dispensing head, where to move the dispensing head to contact the samples, and the pressure to apply to the rear face of the dispensing head to aspirate the desired amount of sample into each conduit of the dispensing head. Once aspirated, the program controls the system to transport the sample-charged dispensing head to a dispensing location for the samples, e.g., to the wells of a thermal plate module, and dispense a predetermined amount of each sample into corresponding wells by modulating the pressure at the rear face of the dispensing head. Once the programmed system has dispensed all of the desired samples in the predetermine locations, which may take multiple dispensing steps (e.g., after intervening dispensing head conduit washing steps), the programmed system disengages the first dispensing head, engages a series of different dispensing heads in succession to aspirate and dispense consumable reagents (e.g., buffers, enzymes, adapters, purification magnetic beads, bulk reagent reservoirs, wash and purification fluids, etc.) in a predetermined order to generate a nucleic acid library from each of the samples. In other words, the program controls the system to sequentially engage a second, third, and/or fourth, etc., dispensing head as needed to dispense reagents as desired into each sample reaction well (e.g., a CLC reaction well). The program may control the system to add each reagent sequentially or to pre-combine multiple regents, e.g., at a reagent mixing location, prior to addition to the reaction well. The program can control the temperature at the thermal chip module following each reagent addition to the CLCs in the CLC reaction wells, e.g., in the form of thermal cycling, as desired for a given NGS library preparation protocol. As noted above, the system can be programmed to add sample identifiers, e.g., nucleic acid barcodes, to the NGS libraries to uniquely identify the nucleic acids in each CLC reaction well according to the sample source.

Following production of the barcoded nucleic acid libraries, the program can control the system to perform a purification operation to produce a product NGS library suitable for use in an NGS sequencing protocol (e.g., as noted above). While resultant barcoded libraries may be purified using any convenient protocol, in some instances the system, when appropriately programmed, is configured to perform a magnetic bead based purification protocol. Details regarding magnetic bead/conduit based purification protocols that may be employed by the system are further described in PCT Application Serial No. PCT/IB2014/002159 published as WO 2014/207577; the disclosure of which is herein incorporated by reference.

Although the foregoing invention has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A composite liquid cell handling system, the system comprising:
a dispensing head comprising:
a rear face;
a dispensing face disposed on the dispensing head opposite the rear face; and
a liquid conduit providing a pathway for fluid communication between the rear face and the dispensing face; and
a pressure source operably attached to the dispensing head and configured to modulate the pressure at the rear face and thereby in the liquid conduit.

2. The composite liquid cell handling system of claim 1, further comprising:
a controller operably attached to the pressure source and configured to cause the pressure source to modulate pressure at the rear face.

3. The composite liquid cell handling system of claim 2, wherein the controller further comprises an input device.

4. The composite liquid cell handling system of claim 3, wherein the controller is programmed to, in response to receiving a signal at the input device:
determine a pressure and time interval based on the signal; and
cause the pressure source to apply the determined pressure for the determined time interval to the rear face of the dispensing head.

5. The composite liquid cell handling system of claim 4, wherein the signal comprises information selected from the group consisting of: (i) a predetermined dispensing quantity of liquid, (ii) a predetermined viscosity, (iii) a predetermined volume of each liquid conduit, and any combination thereof.

6. The composite liquid cell handling system of claim 5, wherein the controller is programmed to determine the pressure and time interval such that, if the determined pressure were applied to the rear face for a time equal to the determined time interval, and the liquid conduit was charged with at least the predetermined volume of a liquid having the predetermined viscosity, the predetermined quantity of the liquid would be dispensed from the liquid conduit at the dispensing face.

7. The composite liquid cell handling system of claim 1, wherein the liquid conduit is defined by an internal wall, and a portion of the internal wall adjacent to the dispensing face is both hydrophobic and oleophobic.

8. The composite liquid cell handling system of claim 1, wherein the liquid conduit, adjacent to the dispensing face, defines a capillary section sized and shaped such that a predetermined liquid disposed within the capillary section would experience a capillary surface tension force that is greater than a predetermined pressure force across the opening of the liquid conduit in the dispensing face, thereby substantially retaining the liquid in the liquid conduit.

9. The composite liquid cell handling system of claim 1, wherein the dispensing head comprises a plurality of liquid conduits each providing a pathway for fluid communication between the rear face and the dispensing face, wherein the pressure source is configured to modulate the pressure in each of the plurality of liquid conduits collectively.

10. The composite liquid cell handling system of claim 9, wherein the plurality of liquid conduits are positioned linearly on the dispensing head.

11. The composite liquid cell handling system of claim 9, wherein the plurality of liquid conduits are positioned in a two-dimensional array on the dispensing head.

12. The composite liquid cell handling system of claim 9, wherein the dispensing head comprises from 5 to 500 liquid conduits.

13. The composite liquid cell handling system of claim 9, wherein the plurality of liquid conduits are spaced to align with the wells of a multi-well receptacle.

14. The composite liquid cell handling system of claim 1, further comprising a transporter configured to translate the dispensing head to any of a plurality of locations.

15. The composite liquid cell handling system of claim 14, wherein the system comprises a plurality of dispensing heads, wherein the transporter is further configured to: (a) operably attach to the pressure source any one of the plurality dispensing heads, and (b) remove from operable attachment to the pressure source a dispensing head operably attached to the pressure source.

16-21. (canceled)

22. A composite liquid cell processing method, the method comprising:
processing a composite liquid cell in a composite liquid cell handling system, the system comprising:
a dispensing head having:
a rear face;
a dispensing face disposed on the dispensing head opposite the rear face; and
a liquid conduit providing a pathway for fluid communication between the rear face and the dispensing face; and
a pressure source operably attached to the dispensing head and configured to modulate pressure at the rear face and thereby in the liquid conduit.

23. The method of claim 22, wherein the composite liquid cell handling system further comprises a controller operably attached to the pressure source and configured to cause the pressure source to modulate pressure to the rear face.

24. The method of claim 23, wherein the controller further comprises an input device.

25. The method of claim 24, wherein the processing step further comprises:
receiving a signal at the input device;
determining in the controller a pressure and time interval based on the signal; and
applying with the pressure source the determined pressure for the determined time interval to the rear face.

26-49. (canceled)

50. A dispensing head comprising:
a rear face;
a dispensing face disposed on the dispensing head opposite the rear face; and
a liquid conduit providing a pathway for fluid communication between the rear face and the dispensing face,
wherein the dispensing head is configured for a pressure source to apply either positive or negative pressure to the rear face and thereby to the liquid conduit.

51-62. (canceled)
